(19) United States
(12) Patent Application Publication
(10) Pub. No.: US 2006/0290135 A1
(43) Pub. Date: Dec. 28, 2006

(54) FINANCIAL PLANNING TOOL

(76) Inventor: Michael A. Altman, Marietta, GA (US)

Correspondence Address: LOUIS VENTRE, JR, 2483 OAKTON HILLS DRIVE, OAKTON, VA, 22124-1530, US

(21) Appl. No.: 11/160,188

(22) Filed: Jun. 13, 2005

(51) Int. Cl. B42D 15/00

(52) U.S. Cl. 283/66.1

(57) ABSTRACT

An apparatus and method of simplifying one's life in the organization, retention, transportation, disclosure and use of financial planning documentation and related items. The apparatus is a pre-printed “SIMPLIFY YOUR LIFE BOX” Document Summary Form to add specific financial planning information and a portable case. The method of using the device involves filling in the pre-printed “SIMPLIFY YOUR LIFE BOX” Document Summary Form; and, placing it and such of the referenced documents and associated items as are available in the portable case.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

An apparatus and method of simplifying one's life in the organization, retention, transportation, disclosure and use of important financial planning items, including information, credentials, instructions, and the means to access those items.

### DESCRIPTION OF PRIOR ART

People today have a large number of important financial planning documents, keys, codes and passwords to keep track of in their lives. As is often the case, documents are stored in many locations and physical items, such as keys, codes and passwords, may be stored in other diverse locations. This physical separation can make it difficult and frustrating for the owner or his estate after the owner's death to locate and use the necessary documents and associated items from time to time when they are needed.

Most responsible people want to make it easier for survivors in their family to get through the estate process with a minimum of frustration at a time of high emotional stress. The present invention attends to this goal and helps to simplify a person's life using a specific financial planning document and associated item management system.

The art of organizing documents and filing is well known in a general sense, being practiced in business and in household affairs for many years. While this prior art addresses organization and retention of records, none has been found to address the combined objectives of organization, retention, transportation, disclosure and use of information and objects, as is the case for the present invention.

In practice, the records management process has been left to the individual to invent his or her own means of organizing his or her information. The sheer number of possible organizing systems is often a cause for survivors to wilt at the prospect of having to make sense out of a deceased person's estate.

Some have attempted to simplify the organizing process, but this usually means using a file folder, labelling it, inserting a document in the folder and placing the folder in a fixed and heavy box or filing cabinet, sometimes within color-coded suspension folders.

An object of the present invention is concentration on organizing a narrow field of important documents and financial related items in one's life. It is further an object to eliminate complexity in the management of the records and certain items associated with the security of those records.

The present invention avoids color coded files, eliminates elaborate labels required to be affixed to files, avoids the need to have hanging file folders on hand, and eliminates the need for a fixed and heavy filing cabinet or box.

Indexes and file guidebooks are taught in the prior art in an effort to simplify the process of finding documents filed on numerous subject areas. U.S. Pat. No. 5,123,676 is an example of this instruction.

The '676 patent is illustrative of an all-encompassing system that requires a dedicated commitment by the user to preparing index entries, a subcategorized guidebook and file folder labels for an ever-increasing file inventory, and then to follow the organizational concepts in filing and retrieving documents. However, as the years go by, lapses in indexing and labelling render the index and guidebook untrustworthy as to comprehensiveness. Also, the file boxes accumulate and the filing cabinet or box hosts a multitude of information, which, while being retained in the file, is often no longer of any value.

The present invention does not require an indexing system, a guidebook or file folder labels. The present invention is a simpler system because it uses a pre-printed form to direct the user's attention to adding information on a limited number of financial planning subjects. Once filled-in by the user, the form is itself a primary record of financial planning information. An object of the present invention is to avoid such information as household bills, personal lifestyle information and medical information included in the '676 patent, because such information tends to accumulate in far greater volume than appropriate for a portable financial planning system.

The prior art teaches filing systems wherein the important and unimportant documents are mixed together and accumulate in the filing system in a great variety of folders, adding to the difficulty for the owner or his survivor to wade through in search of important financial documents. Often, separating the mundane daily, monthly or regular household or medical bills, from the important lifetime credentials, such as long term capital investments, birth certificates, computer passwords, stock certificates, wills, property titles, etc., can be a frustrating and daunting task. The present invention addresses this deficiency and teaches that the important documents should be attended to by a separate system and either retained in a portable case or referenced as to their location.

Representative of the prior art is U.S. Pat. No. 5,547,226, which describes a household filing system to simplify organization and operation of household current affairs, including incoming mail, current bills to be paid, general receipts, community matters, as well as organization and storage of relevant data and documents. The '226 patent attempts to mix the organization, storage, retrieval and use of all manner of current household operational and family activities. In the first instance, the '226 patent does not, as does the present invention, focus on the limited purposes of organization, retention, transportation, disclosure and use of important financial planning documents and items.

It is an object of the invention to limit the focus to financial planning on both documentation and related items combined with portability in the storage case. These are three important distinctions representing unique utilities in the present invention.

The present invention solves five primary deficiencies in the prior art, represented by the '226 patent: Firstly, the prior art is focused on an organizational tool for a broad variety of documents attendant to affairs in the conduct of daily life, rather than on organizing the important financial planning documentation and related items. The field of the present invention is significantly narrower than the field of all personal and household documentation and in addition the invention has important objectives beyond document filing, which extend to the control and location of keys and other security devices related to these financial planning objectives.

Secondly, by including all manner of daily operational documents, the prior art, represented by the '226 patent, necessarily has the potential for a number of people in the household to use the system on a daily basis. In contrast, the present invention involves far more control over access. This is because it is focused on financial planning documents and items. For these documents and items, there is only occasional need for access, perhaps monthly, by the owner or other individuals in a household and then upon an owner's death, by those who must administer the owner's estate.

Thirdly, the prior art represented by the '226 patent necessarily involves a significant amount of daily paperwork entering and leaving the files. With so many filing accesses, there is a greater likelihood of accidentally misplacing or discarding an important document, for example, with daily mail or other of the more transitory documents involving everyday life. It is an object of the present invention to deal with a limited number of financial planning documents and items, so that there are far fewer accesses and chances for losing those documents and items.

Fourthly, the prior art, represented by the '226 patent, uses file containers in which a series of color-coded file folders are supported. It requires that the owner pay a great deal of attention to organizational detail, which is a significant complication for most individuals in today's busy world. The more details a person has to remember and components he has to have available to practice the organizational system, the more likely a component will be missing and that simplicity will be lost for the user.

The present invention does not require hanging folders, color-coded folders or any great continuing attention to detail. In practicing the invention, a user must fill in the form only with relevant and important financial planning information, and then place the available items referred to in the form in a portable case. The object of the present invention is life simplification in regard to financial planning, and is uncomplicated by hanging folders and color-coded folders.

Fifthly, the '226 patent is unconcerned with the weight and ease of transportability of the filing box. The hanging folders and color-coded folders add unnecessary weight to the file box, but this is not a concern because limited weight and enabling transportability are not objectives in the '226 patent. In contrast, an object of the present invention is to minimize weight by including only important financial planning documents and items in a box that is easily transported, for example, to a financial advisor's office, an attorney's office, a bank, or an insurance company office. This weight minimization objective complements another objective of the present invention, and that is that the box or case be easily transported by the owner or his executor to facilitate appropriate disclosure and use of the financial information and objects within.

It is, therefore, apparent that a need exists for an apparatus and method of simplifying one's life in the organization, retention, transportation, disclosure and use of important financial planning items, including information, credentials, instructions, and the means to access those items.

### BRIEF SUMMARY OF THE INVENTION

An apparatus and method of simplifying one's life in the organization, retention, transportation, disclosure and use of financial planning documentation and related items. The apparatus is a pre-printed “SIMPLIFY YOUR LIFE BOX” Document Summary Form divided into 5 categories relating to family information, running your household information, location information on items and documents, financial information, and event of death information; and a portable case. The method of using the device involves filling in said pre-printed “SIMPLIFY YOUR LIFE BOX” Document Summary Form; and placing in said portable case the filled-in “SIMPLIFY YOUR LIFE BOX” Document Summary Form and such of the referenced documents and associated items as are available.

### BRIEF DESCRIPTION OF THE DRAWINGS

FIG. 1 is “Family Information,” Section 1 of the pre-printed “SIMPLIFY YOUR LIFE BOX” Document Summary Form.

FIG. 2 is “Running Your Household Information,” Section 2 of the pre-printed “SIMPLIFY YOUR LIFE BOX” Document Summary Form.

FIG. 3 is “Where Can I Find It Information,” Section 3 of the pre-printed “SIMPLIFY YOUR LIFE BOX” Document Summary Form.

FIG. 4 is “Organizing Your Financial Information,” first half of Section 4 of the pre-printed “SIMPLIFY YOUR LIFE BOX” Document Summary Form.

FIG. 5 is “Organizing Your Financial Information,” second half of Section 4 of the pre-printed “SIMPLIFY YOUR LIFE BOX” Document Summary Form.

FIG. 6 is “In the Event of My Death Information,” Section 5 of the pre-printed “SIMPLIFY YOUR LIFE BOX” Document Summary Form.

FIG. 7 is a portable case for financial planning documents and item retention.

FIG. 8 is a representation of the pre-printed “SIMPLIFY YOUR LIFE BOX” Document Summary Form showing the portable case on the cover of the form.

### DETAILED DESCRIPTION OF THE INVENTION

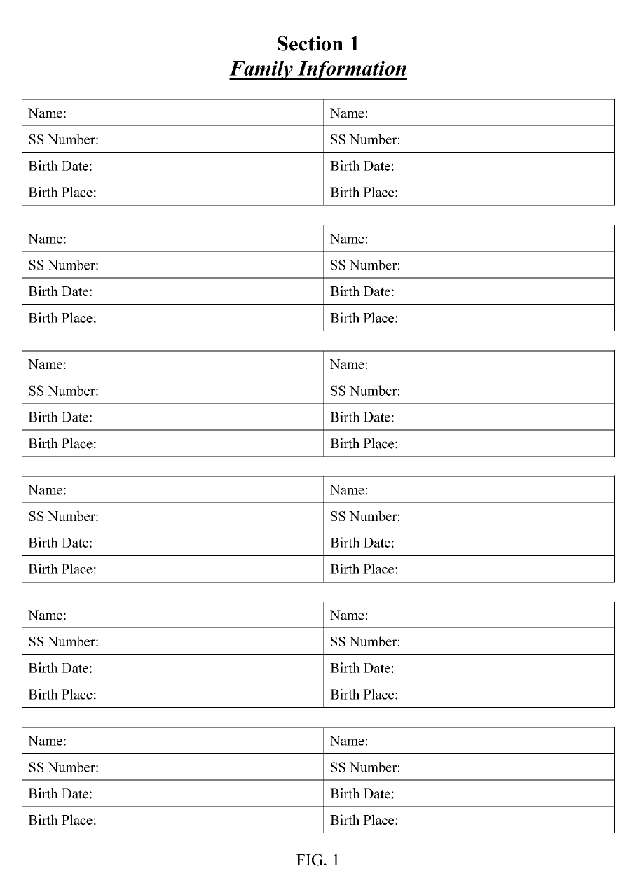

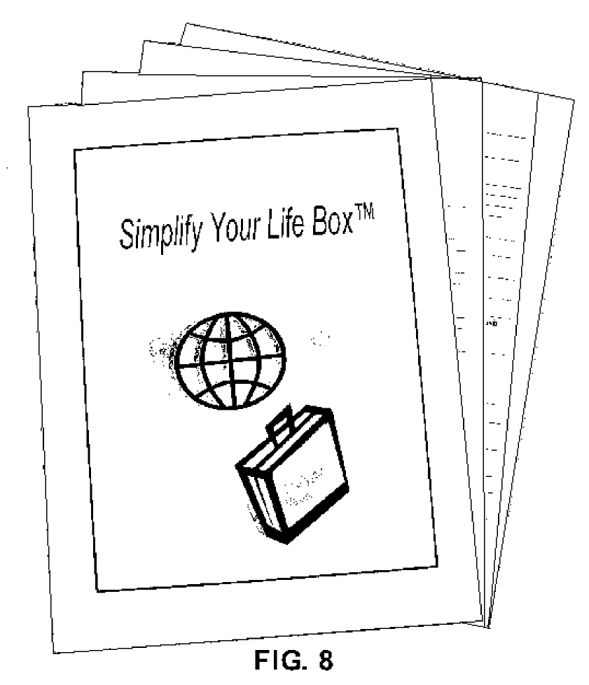

The Financial Planning Tool is a financial planning device illustrated in preferred embodiment in FIGS. 1 through 8, and a method of using the device. It is intended to be a tool simplify one's life and, thus, this Financial Planning Tool method and device will be sold under the trademark “SIMPLIFY YOUR LIFE BOX,” which is part of the name of one of the two components of the device. FIG. 8 is a representation of that component, the pre-printed “SIMPLIFY YOUR LIFE BOX” Document Summary Form with the portable case on the cover of the form. The invention is intended to simplify the organization, retention, transportation, disclosure and use of important financial planning documents and items.

The device is composed of a means for identifying and documenting financial planning information and a portable case having dimensions suitable for holding these means together with documents and associated items therein identified. The means for identifying and documenting financial planning information is a pre-printed “SIMPLIFY YOUR LIFE BOX” Document Summary Form substantially illustrated in FIGS. 1 through 7. The “SIMPLIFY YOUR LIFE BOX” Document Summary Form is titled, “Simplify Your Life Box Document Summary” and is divided into 5 sections, which limits and organizes the financial planning information to be added by the owner seeking to simplify his or her life by employing the invention.

The sections of the “SIMPLIFY YOUR LIFE BOX” Document Summary Form solicit specific information and permit the owner to add other information in blanks provided for that purpose. The 5 sections address financial planning associated with Family Information, Running Your Household Information, Location Information on Items and Documents, Financial Information, and Event of Death Information.

The specific information sought relevant to Family Information is shown in FIG. 1. It includes the name, social security number, birth date and birthplace for the owner and owner's family. This is important information relative to the administration of the owner's estate.

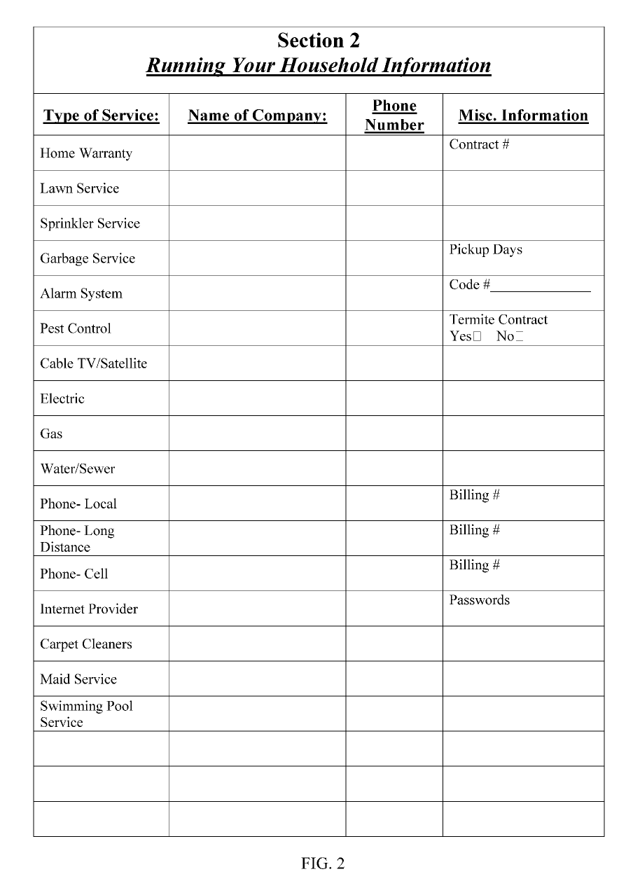

The specific information sought relevant to Running Your Household Information is shown in FIG. 2. It includes providers, contact numbers and other relevant information for the owner's home warranty, lawn service, sprinkler service, garbage service, alarm system, pest control, cable tv/satellite, electric, gas, water/sewer, phone-local, phone-long distance, phone-cell, internet provider, carpet cleaners, maid service and swimming pool service. All of this specific information will aid the owner, or if the owner becomes sick or dies, will simplify the seamless administration of his household and the owner's financial estate.

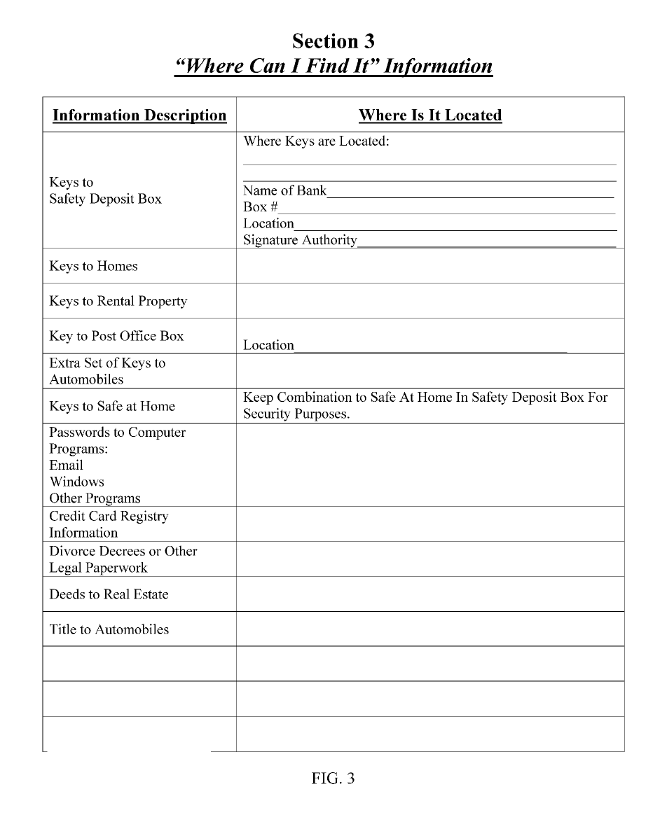

The specific information sought relevant to “Where Can I Find It Information” is illustrated in FIG. 3. It includes location information on keys to safety deposit boxes, keys to homes, keys to post office box, extra set of keys to automobiles, keys to safe at home, passwords to computer programs, credit card registry information, divorce decrees, deeds to real estate, title to automobiles. All of this information is essential to the unfettered operation of the owner's financial affairs.

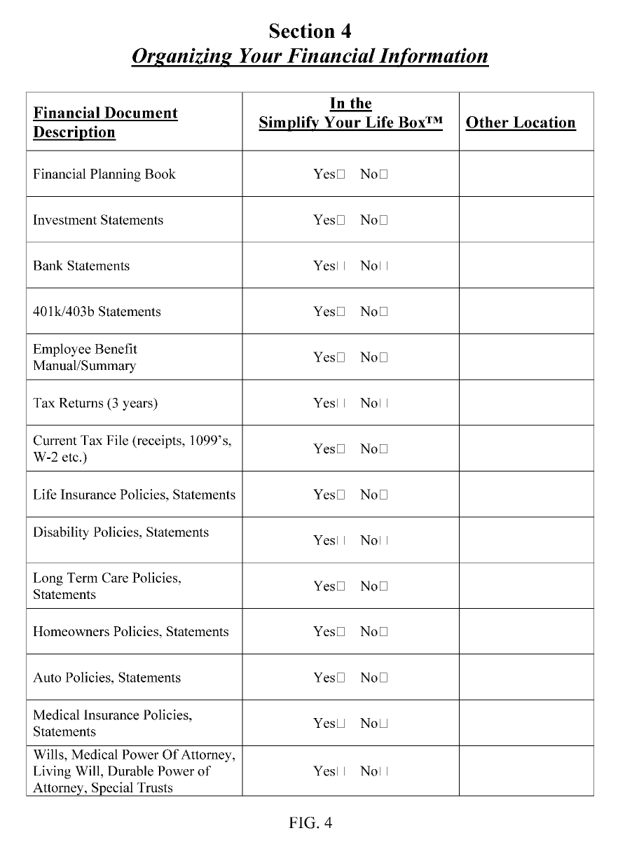

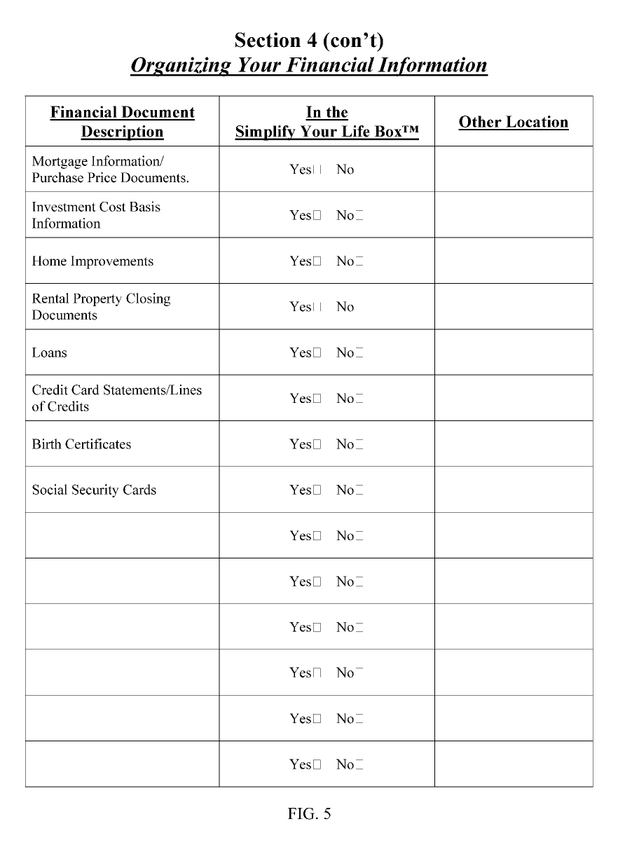

The specific information sought relevant to “Financial Information” is illustrated in FIG. 4 and in FIG. 5. It includes notations of the existence and location of a financial planning book, investment statements, bank statements, retirement account statements, employee benefit manual or summary, tax returns, tax receipts, life insurance policies and statements, disability policies and statements, long-term care policies and statements, homeowners policies and statements, automobile policies and statements, medical insurance policies and statements, wills, medical power of attorney, living will, durable power of attorney, special trusts, mortgages, investment cost basis, home improvements, rental property, loans, credit card statements, birth certificates and social security cards. Knowledge of this information is again essential to the unfettered operation of the owner's financial affairs.

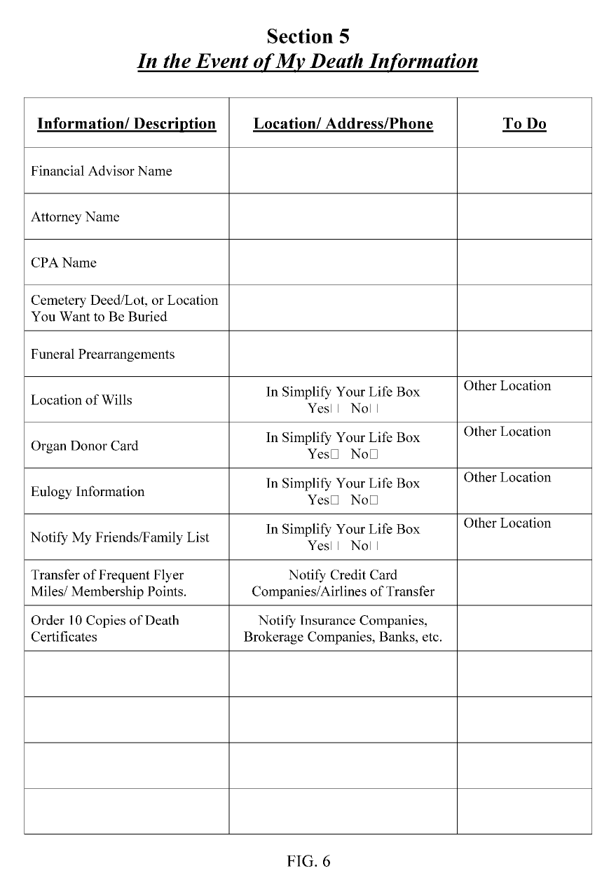

The specific information sought relevant to “In the Event of Death Information” is illustrated in FIG. 6. It includes identification and useful information on the owner's financial advisor, attorney, accountant, cemetery deed, funeral prearrangements, location of wills, organ donor card, eulogy information, list of family and friends to notify, transfer of frequent flyer miles, and instructions on where to send copies of the death certificate. This information will facilitate the administration of the owner's estate and the concluding of his financial affairs.

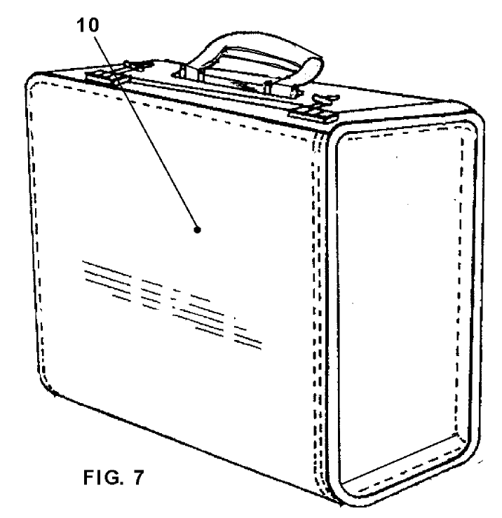

The second component of the invention apparatus is a portable case illustrated in FIG. 7. This component of the device, as illustrated, is a “catalog case,” commonly available in any store selling briefcases. There are two simple requirements for the case that must be satisfied in employing the invention: The case must be portable, and preferably easily transportable by the owner; and the case must have dimensions suitable for holding the filled-in “Simplify Your Life Box Document Summary” form together with any of the documents therein referred to and the extra keys or other associated items therein identified.

The catalog case illustrated in FIG. 7 has dimensions of about 8 inches wide, 13 inches tall and 18 inches wide, which is preferred for most applications of the invention. The illustrated case (10) has a convenient handle to promote the transportability of the box using a single hand. A smaller or larger briefcase or box than shown and having other means to assist in transportability is within the scope of the intended invention, as long as the box is of sufficient size for the documents and items referenced in the form and is conveniently transportable by the owner, the owner's designee, or the owner's successor in interest.

In the method of the invention, an owner fills in the specific information sought in the “SIMPLIFY YOUR LIFE BOX” Document Summary Form. Upon completion, the owner places the filled in form in the portable case together with available documents and items referenced therein.

Not all of the documents or records referenced in the “SIMPLIFY YOUR LIFE BOX” Document Summary Form will be available for storage in the case. Some may be stored in one or more safety deposit boxes or other locations. However, for the records that are available, the owner then places those records in the case with the “SIMPLIFY YOUR LIFE BOX” Document Summary Form. Similarly, the keys and other objects referred to in the “SIMPLIFY YOUR LIFE BOX” Document Summary Form may be stored in the case or in other locations, as indicated on the “SIMPLIFY YOUR LIFE BOX” Document Summary Form.

In an alternative embodiment, the method of the invention will include a step of periodically updating the “SIMPLIFY YOUR LIFE BOX” Document Summary Form with any changed information. Each owner's situation is unique to that owner. There may be no changes in the information or records for some owners. So the updating step may not be required. For others, the information may change occasionally and thus the updating step would be performed occasionally. Finally, for yet others, the information may change regularly. So the updating step for them would be performed regularly, for example on a monthly basis.

In yet another alternative embodiment, the owner, the owner's designee or the owner's estate administrator will transport the portable case to a location where contents of the portable case are disclosed and used. In these embodiments, the advantage of the portability of the case is manifest. Example situations where this step would be performed involve legal situations where the financial matters are in question, to facilitate insurance claims, to administer the estate of the deceased owner, or as a tool for the financial advisor to update the owner's financial records.

While there has been described herein what is considered to be the preferred exemplary embodiment of the present invention, other modifications of the present invention shall be apparent to those skilled in the art from the teachings herein, and it is therefore, desired to be secured in the appended claim all such modifications as fall within the true spirit and scope of the invention. Accordingly, what is desired to be secured by Letters Patent of the United States is the invention as defined and differentiated in the claims that follow.

What is claimed is:

1. A device for the organization, retention, transportation, disclosure and use of important financial planning documents and items comprising, a means for identifying and documenting financial planning information; and a portable case having dimensions suitable for holding said means for identifying and documenting financial planning information together with documents and associated items therein identified.

2. The device of claim 1 wherein the portable case is a catalog case.

3. The catalog case of claim 2 having dimensions of about 8 inches wide, 13 inches tall and 18 inches wide.

4. A method of organizing and simplifying a person's life using the device of claim 1 comprising the steps of,
(a) filling in said means for identifying and documenting financial planning information; and,
(b) placing said filled in means in said portable box together with such of the identified and documented financial planning information and associated items as are available.

5. The process of claim 4 further comprising the step of periodically updating the filled-in means for identifying and documenting financial planning information.

6. The process of claim 4 further comprising the step of transporting the portable box to a location where contents of the portable box are disclosed and used.
